(19) United States
(12) Patent Application Publication
(10) Pub. No.: US 2009/0298859 A1
(43) Pub. Date: Dec. 3, 2009

(54) METHOD FOR TREATING PLANTS

(75) Inventors: Kinya Futakuchi, Tokyo (JP); Yoshiaki Yamashita, Tokyo (JP); Hiroyuki Hasebe, Tokyo (JP)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/278,787

(22) PCT Filed: Feb. 7, 2007
(86) PCT No.: PCT/EP07/01020

§ 371 Date: May 15, 2009

(30) Foreign Application Priority Data
Feb. 14, 2006 (GB) 0602958.1

(51) Int. Cl. A01N 43/54

(52) U.S. Cl. 514/269

(57) ABSTRACT

The present invention relates to the use of a fungicide selected from the group consisting of (i) a strobilurin or strobilurin-type fungicide or (ii) a triazole or an insecticide selected from the group consisting of (i) an avermectin, (ii) an organophosphate, (iii) a benzoylurea or (iv) a neonicotinoid in the production of a crop plant having raised levels of anti-oxidants.

This invention relates to the use of certain fungicides and insecticides in the production of a crop plant having raised levels of anti-oxidants. The invention also relates to a method for increasing the anti-oxidant content of crop plants and to crops having raised levels of anti-oxidants.

Anti-oxidants are chemicals that reduce the rate of oxidation reactions. In particular, they are able to reduce oxidative damage to cells and biomolecules. As such, they are widely used as ingredients in dietary supplements for health purposes. Indeed, recent medical research suggests that there is a high correlation between oxidative damage and the occurrence of disease. In particular, health benefits for humans from consumption of anti-oxidants are said to include anti-cancer effects, anti-ageing effects, action against urinary tract infection, anti-inflammatory activity and protection against cardiovascular disease. A number of anti-oxidants, such as polyphenols and carotenoids, are naturally found in plants. Polyphenols are characterized by the presence of more than one phenol group per molecule. They are produced by plant photosynthesis and are basic components in the pigments and the bitter taste of certain plants. In the plants, the polyphenols are responsible for plant cell production and activation. Examples of polyphenols in crop plants include catechin, found in tea, quercetin, found in citrus fruit, red wine, onion, broccoli, lettuce, sweet pepper and cocoa, xanthofumol found in hops, anthocyanin, found in blueberries, strawberries' and egg plant, and isoflavones found in soya and dry beans. Other sources of polyphenols include olive oil, dark chocolate and pomegranates. Carotenoids are organic pigments characterised by a large (35 to 40 carbon atoms) polyene chain, sometimes terminated by ring structures. In plants, carotenoids play a vital role in the photosynthetic reaction centre where they either participate in the energy transfer process or protect the reaction centre from oxidative damage. Examples of carotenoids include lycopene, found in tomatoes and β-carotene, found in carrots and pumpkins.

There is an increasing public awareness of the potential or perceived health benefits of various plants, and as a result of this, there is a growing demand for crop plants with higher levels of anti-oxidants, including polyphenols and carotenoids. The present invention relates to a method of increasing the level of anti-oxidants in crop plants at their time of harvest by the pre-harvest treatment of the crop plants with a strobilurin or strobilurin-type fungicide (for example azoxystrobin or trifloxystrobin), a triazole fungicide (for example difenoconazole), an avermectin (for example emamectin), an organophosphate insecticide (for example methidathion), a benzoylurea insecticide (for example lufenuron) or a neonicotinoid insecticide (for example thiamethoxam).

Thus, according to the present invention, there is provided the use of a fungicide selected from the group consisting of (i) a strobilurin or strobilurin-type fungicide or (ii) a triazole or an insecticide selected from the group consisting of (i) an avermectin, (ii) an organophosphate, (iii) a benzoylurea or (iv) a neonicotinoid in the production of a crop plant having raised levels of anti-oxidants. Also provided is a method for producing a crop plant having raised levels of anti-oxidants, comprising applying to the foliage of the crop plant, during its growing period, an effective amount of a fungicide selected from the group consisting of (i) a strobilurin or strobilurin-type fungicide or (ii) a triazole or an insecticide selected from the group consisting of (i) an avermectin, (ii) an organophosphate, (iii) a benzoylurea or (iv) a neonicotinoid.

In the context of this invention, ‘crop plant’ includes any plant, parts or all of which either can be consumed by humans or from which extracts can be made which can be consumed by humans. ‘Extracts’ includes those made by aqueous or solvent extraction, for examples teas, including herbal teas, or by fermentation, for example wine or beer. ‘Parts’ includes leaves, roots, stem and juice. Examples of crop plants, parts or all of which can be consumed by humans include citrus fruit trees, such as oranges or limes, olive trees, date trees, beans such as soybeans and drybeans, vegetables which produce edible green leaves such as brussel sprouts, broccoli, cabbage, celery, chard (including Swiss chard), chicory, collards, culinary herbs, dandelions, endive, escarole, garden cress, kale, lettuce, mustard, New Zealand spinach, pak choi, parsley, radicchio, spinach and watercress, broccoli, bush fruits such as blueberries, blackberries, raspberries, blackcurrants, redcurrants and grapes, root crops such as onions and other crops such as strawberries, egg plant, sweet pepper, carrots, pumpkins and tomato. Examples of crop plants from which extracts can be made which can be consumed by humans include tea plants from which tea can be made, hop plants from which beer can be made and grapes from which wine can be made.

The invention is particularly useful when applied to certain plants such as olive trees, grapes, soybeans, drybeans, broccoli, cocoa, citrus trees, blueberries, strawberries, tomatoes, carrot and tea plants. Suitably, the crop plant is a tea, tomato, carrot, soybean or strawberry plant and most suitably, a tea plant. The invention is most particularly useful when applied to tea plants, such as Camellia sinensis, or Camellia assamica. In a preferred embodiment, the crop plant is not a hop plant.

Suitably the anti-oxidant is a polyphenol or a carotenoid. More suitably, the polyphenol is catechin, isoflavone or anthocyanin and the carotenoid is lycopene or β-carotene. Most suitably, the polyphenol is catechin and the carotenoid is lycopene.

Strobilurin and strobilurin-type fungicides are a well-known class of fungicides that act by inhibiting mitochondrial respiration by blocking electron transfer between cytochrome b and cytochrome c₁ at the ubiquinol oxidising site. They include the methoxyacrylate strobilurins such as azoxystrobin and picoxystrobin, the oximinoacetate strobilurins such as kresoxim-methyl and trifloxystrobin, the oximinoacetamide strobilurins such as dimoxystrobin, metominostrobin, orysastrobin (BAS 520) and the strobilurin of the formula:

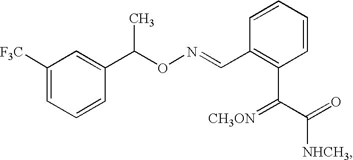

the dihydrodioxazine strobilurins such as fluoxastrobin, the methoxycarbamate strobilurins such as pyraclostrobin, the strobilurin of the formula:

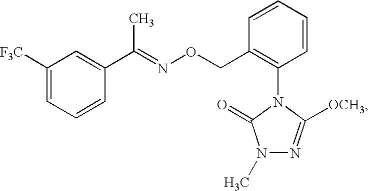

the imidazolinones strobilurin-types such as fenamidone, and the oxazolidinedione strobilurin-types such as famoxadone. Of particular interest to the present invention are azoxystrobin and trifloxystrobin and, in particular, azoxystrobin.

Triazoles are a well-known class of fungicides that act by inhibiting sterol biosynthesis. They include azaconazole, bitertanol, bromuconazole, cyproconazole, difenoconazole, diniconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol and triticonazole. Of particular interest to the present invention is difenoconazole, which inhibits cell membrane ergosterol biosynthesis, stopping development of the fungus.

Avermectin insecticides are a well-known class of insecticides that act by activating chloride channels. They include abamectin and emamectin (most commonly used as its benzoate salt) both of which act by stimulating the release of γ-aminobutyric acid, an inhibitory neurotransmitter, thus causing paralysis and then death of the target insect. Of particular interest to the present invention is emamectin.

Organophosphates are a well-known class of insecticides that act by inhibiting the insect acetylcholinesterase. They include acephate, azamethiphos, azinphos-ethyl or methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos, dicrotophos, dimethoate, dimethylvinphos, disulfoton, EPN, ethion, ethoprophos, famphur, fenamiphos, fenitrothion, fenthion, fosthiazate, heptenophos, isofenphos-methyl, isopropyl O-(methoxyaminothiophosphoryl)salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion. Of particular interest to the present invention is methidathion.

Benzoylureas are a well-known class of insecticides that act by inhibiting chitin biosynthesis meaning that target insect larvae are unable to moult and also cease feeding. They include bistrifluron, chlorfluazuron, diflubenzuron, fluazuron, flucycloxuron, flufenoxuron, hexaflumuron, lufenuron, novaluron, noviflumuron, teflubenzuron and triflumuron. Of particular interest to the present invention is lufenuron.

Neonicotinoids are a well-known class of insecticides that are agonists/antagonists of the nicotinic acetylcholine receptor affecting the synapses in the insect central nervous system. They include acetamprid, clothianidin, dinotefuran, imidacloprid, nitenpyram, thiacloprid and thiamethoxam. Of particular interest to the present invention is thiamethoxam.

In one embodiment, a fungicide is used in the use and method of the invention. In a further embodiment, the fungicide is a strobilurin, in particular, azoxystrobin or trifloxystrobin. Most suitably, the strobilurin is azoxystrobin. In a further embodiment, the fungicide is a triazole. Most suitably, the triazole is difenoconazole.

In one embodiment, an insecticide is used in the use and method of the invention. In a further embodiment, the insecticide is an avermectin, in particular, emamectin or its benzoate salt. In a further embodiment, the insecticide is an organophosphate, in particular, methidathion. In a further embodiment, the insecticide is a benzoylurea, in particular, lufenuron. In a further embodiment, the insecticide is a neonicotinoid, in particular thiamethoxam. Preferably, when lufenuron and thiamethoxam are used, they are used together.

The fungicide or insecticide of the present invention can be applied one or more times to the crop plant during its growing period. For instance, in the case of application to tea, a strobilurin or strobilurin-type fungicide is typically applied 1-3 times during the growing period. These applications are typically made 1-3 weeks, respectively, after planting. The fungicides and insecticides of the present invention may be applied to the plant in order to control fungal disease or insect infestation as well as increasing anti-oxidant levels. Alternatively, they may be applied in the absence of fungal or insecticide pressure in order to raise the anti-oxidant level in the crop plant of interest. Optionally, the fungicide or insecticide of the invention can be applied in addition to one or more other fungicides that may be used to combat fungal infections of the plant or in addition to one or more insecticides that can be used to combat insect infestations of the plant. In particular, the fungicides and insecticides of the invention may be mixed (a) with each other, (b) with a fungicide selected from the group consisting of chlorothalonil, cymoxonil, cyproconazole, difenoconazole, fenpropidin, fenpropimorph, fluazinam, fludioxonil, folpet, hexaconazole, metalaxyl-M, propiconazole, pyroquilon, tebuconazole, thiabendazole or thiram or (c) with an insecticide selected from the group consisting of cartap, cypermethrin, λ-cyhalothrin, diazinon, fipronil, permethrin, profenphos or tefluthrin. For example azoxystrobin may be mixed with chlorothalonil, cyproconazole, difenoconazole, folpet or hexaconazole and, more particularly, with chlorothalonil.

The amount of fungicide or insecticide applied depends, inter alia, on the number of applications made during the growing period, on the particular fungicide or insecticide used and on how the fungicide or insecticide is formulated. A skilled person can determine the amount without undue experimentation. Typically it is at about the level the fungicide or insecticide is normally applied as a fungicide or insecticide. For example, in the case of azoxystrobin, which is sold in the form of a suspension concentrate (the commercial products Amistar™ or Ortiva™ are sold as suspension concentrates containing 250 g/l azoxystrobin) 100 to 400 g/ha, for example 200 to 300 g/ha, typically 250 g/ha, is an effective amount.

The fungicide or insecticide can be used in unmodified form but is normally used in the form of a formulation, in which it is mixed with a carrier, surfactant and/or other application-promoting adjuvant of the type customarily employed in agrochemical formulation technology.

Suitable carriers and adjuvants can be solid or liquid and are, for example, natural or regenerated mineral substances, solvents, dispersants, wetting agents, tackifiers, thickeners, binders or fertilisers. They are conveniently formulated in known manner to form, for example, emulsifiable concentrates, coatable pastes, directly sprayable or dilutable solutions, dilute emulsions, wettable powders, soluble powders, dusts, granules or capsules, for instance by encapsulation in polymers substances. The method of application, such as spraying, atomising, dusting, scattering, coating or pouring can be chosen in accordance with the prevailing circumstances.

The formulations can be prepared in known manner, typically by intimately mixing, grinding and/or extruding the fungicide or insecticide with an extender, for example, a solvent or a solid or liquid carrier and, where appropriate, one or more surface-active compounds (surfactants).

The agrochemical composition generally comprises from 0.1 to 99%, preferably from 0.1 to 95%, of the fungicide or insecticide and from 99.9 to 1%, preferably 99.9 to 5%, of a solid or liquid carrier and/or adjuvant, and 0 to 25%, preferably, 0.1 to 25%, of a surfactant.

Whereas commercial products or wet or dry dressings are preferably formulated as concentrates, the end user will normally use diluted formulations for developing plants.

The solid carriers typically used for dusts and dispersible powders are calcite, talcum, kaolin, montmorillonite and attapulgite, highly dispersed silicic acid or absorbent polymers. Suitable granulated adsorptive granular carriers are pumice, broken brick, sepiolite and bentonite, and suitable non-sorptive carriers are typically calcite and dolomite.

Depending on the nature of the particular fungicide or insecticide to be formulated, suitable surface-active compounds are non-ionic, cationic and/or anionic surfactants having good emulsifying, dispersing and/or wetting properties. The term “surfactant” also includes a mixture of surfactants.

The surfactants customarily employed in formulation technology may be found in the following literature: “McCutcheon's Detergents and Emulsifiers Annual”, MC Publishing Corp., Glen Rock, N.J., 1988; and M. and J. Ash, “Encyclopedia of Surfactants”, Vol. I-III, Chemical Publishing Co., New York, 1980-1981.

‘Raised’ levels of anti-oxidants means that the anti-oxidants can be detected at a higher levels than in untreated plants grown in comparable conditions, for example 5% or more higher, preferably 10% or more higher. Anti-oxidant levels can be detected using standard methods.

The invention also provides a crop having raised levels of anti-oxidants, the crop being derived from a crop plant which has been treated with (i) a strobilurin or strobilurin-type fungicide or (ii) a triazole or an insecticide selected from the group consisting of (i) an avermectin, (ii) an organophosphate, (iii) a benzoylurea or (iv) a neonicotinoid. ‘Crop’ means the part of the crop plant which is harvested for consumption or use in preparing extracts for consumption.

According to the present invention, there is also provided a method for producing a tea plant having raised levels of polyphenols, comprising applying to the foliage of the tea plant, during its growing period, an effective amount of a strobilurin or strobilurin-type fungicide. Suitably, the strobilurin is azoxystrobin.

According to the present invention there is also provided a tea plant having raised levels of polyphenols which has been treated with an effective amount of a strobilurin or a strobilurin-type fungicide during its growing period.

The invention will now be illustrated by means of the following examples;

### EXAMPLES

### Example 1

### Application of Azoxystrobin, Emamectin, Difenoconazole Trifloxystrobin or a Thiamethoxam/Lufenuron Mixture to Tea Plants

Tea plants (Japanese green tea, Yabukita) were grown in 5 m² plots, and the leaves were harvested. The harvested leaves were tested for polyphenols. Fourteen days before harvest, the tea plants were sprayed with a commercial formulation of emamectin benzoate (Affirm™), difenoconazole (Score™), methidathion (Supracid™), azoxystrobin (Amistar™) or a mixture of lufenuron and thiamethoxam. An otherwise identical set of tea plants were left untreated. The content of various polyphenols in the leaves from treated and untreated plants are given in Table 1:

TABLE 1

| | mg polyphenol/100 g tea leaves | | | | | |
|---|---|---|---|---|---|---|
| | Untreated | EMA | MTH | DFZ | LUF + TMX | AZO |
| Epicatechin | 940 | 960 | 1100 | 950 | 1000 | 930 |
| Epigalocatechin | 4300 | 4600 | 4500 | 4300 | 4700 | 4800 |
| Epigalocatechin | 5300 | 5600 | 5700 | 5900 | 5700 | 6200 |
| gallate | | | | | | |
| Epicatechin gallate | 860 | 890 | 1100 | 970 | 920 | 960 |
| Total catechin (g) | 11,400 | 12050 | 12400 | 12120 | 12320 | 12,890 |
| Total catechin (%)¹ | 100% | 106% | 109% | 106% | 108% | 113% |

¹when compared to untreated.

The experiment was repeated using either azoxystrobin or trifloxystrobin. The content of various polyphenols in the leaves from treated and untreated plants are given in Table 2:

TABLE 2

| | mg polyphenol/g tea leaves | | |
|---|---|---|---|
| | Untreated | Azoxystrobin | Trifloxystrobin |
| Epicatechin | 22.1 | 24.5 | 23.8 |
| Epigalocatechin | 165.4 | 178.8 | 190.1 |
| Epigalocatechin gallate | 151.0 | 160.6 | 163.0 |
| Epicatechin gallate | 30.1 | 31.1 | 32.4 |
| Total catechin | 368.6 | 395.0 | 409.3 |
| % compared to untreated | 100% | 107% | 110% |

Both trials detailed above were carried out in the autumn. A further trial carried out in the summer season did not show such a marked increase in polyphenol content with azoxystrobin-treated tea leaves showing between 99 and 103% of the polyphenol content of the control leaves. While not wanted to be bound by theory, it seems as though azoxystrobin has the effect of intensifying photosynthesis and hence catechin production (as catechins are products of photosynthesis). It is proposed that, when photosynthesis is active (e.g. in the summer season), addition of azoxystrobin may not enhance photosynthesis further and thus may not be able to further raise catechin levels.

### Example 2

### Application of Azoxystrobin to Tomato Plants

Tomato plants (Variety: Sunroad) were grown and the tomatoes were harvested after spraying with a conventional fungicide treatment and with the conventional treatment plus azoxystrobin. The harvested tomatoes were stored at room temperature and tested for lycopene concentration 2, 5, 9 and 12 days after sample harvesting (three tomatoes were chosen at random from each box on each day of testing). The content of lycopene in the tomatoes is given in Table 3:

TABLE 3

mg lycopene/100 g tomato

| Sample | Replicate | 2 | 5 | 9 | 12 |
|---|---|---|---|---|---|
| Az-treated | 1 | 5.69 | 8.36 | 9.78 | 8.27 |
| | 2 | 5.67 | 8.87 | 9.14 | 8.88 |
| | 3 | 5.14 | 6.01 | 8.32 | 9.24 |
| | Mean | 5.50 | 7.75 | 9.08 | 8.79 |
| Control | 1 | 3.77 | 7.16 | 6.85 | 7.76 |
| | 2 | 4.99 | 5.49 | 7.89 | 9.23 |
| | 3 | 3.91 | 5.76 | 6.40 | 7.13 |
| | Mean | 4.22 | 6.14 | 7.05 | 8.04 |

It is clear from this table that azoxystrobin-treated tomatoes show raised lycopene concentration when compared to the control tomatoes.

When this study was repeated using similar conditions but on a smaller scale, a marked rise in lycopene content was not observed (control: 11.7 mg lycopene/100 g tomato; azoxystrobin treated: 10.7 mg lycopene/100 g tomato).

### Example 3

### Application of Azoxystrobin to Carrot Plants

Carrot plants were grown and the carrots were harvested after spraying twice with a conventional fungicide treatment (chlorothalonil, copper hydroxide, iminoctazine polyoxin and tolclofos-methyl) and with the conventional treatment plus Amistar Opti™ (azoxystrobin and chlorothalonil). Some of the harvested carrots were analysed immediately on harvest for β-carotene while others were stored for a week after harvest before analysis. Those analysed immediately did not show an increase in β-carotene levels in the azoxystrobin-treated plants compared with those treated with a conventional fungicide regime. However, analysis of those carrots stored for one week showed a clear increase in β-carotene levels (conventional treatment: 6.59 mg β-carotene/100 g carrot; azoxystrobin treatment: 7.48 mg β-carotene/100 g carrot). It seems therefore that azoxystrobin has a clear effect on β-carotene levels in mature carrots.

### Example 4

### Studies on Other Crops

Similar work was carried out to look at isoflavone levels in soybean and anthocyanin levels in eggplant and strawberry on treatment of the plants with azoxystrobin. Azoxystrobin treatment was found to increase isoflavone levels by 8% in soybean (control: 120 mg isoflavone/100 g soybean; azoxystrobin treated: 130 mg isoflavone/100 g soybean). In addition, it also raised anthocyanin levels in strawberry by 50% (control: 200-220 mg anthocyanin/100 g strawberry; azoxystrobin treated: 210-420 mg anthocyanin/100 g strawberry), although it seemed to have no effect on anthocyanin levels in egg plant.

1. A method comprising: applying a fungicide chosen from (i) a strobilurin or strobilurin-type fungicide or (ii) a triazole or an insecticide chosen from (i) an avermectin, (ii) an organophosphate, (iii) a benzoylurea or (iv) a neonicotinoid to a crop plant having a raised level of an anti-oxidant.

2. The method of claim 1, wherein the crop plant is a tea, tomato, carrot or strawberry plant.

3. The method of claim 2, wherein the crop plant is a tea plant.

4. The method of claim 1, wherein the anti-oxidant is a polyphenol or a carotenoid.

5. The method of claim 1, wherein a fungicide is chosen.

6. The method of claim 5, wherein the fungicide is a strobilurin.

7. The method of claim 6, wherein the strobilurin is azoxystrobin or trifloxystrobin.

8. The method of claim 6, wherein the strobilurin is azoxystrobin.

9. A method for producing a crop plant having raised levels of polyphenols, comprising applying to the foliage of the crop plant, during its growing period, an effective amount of a fungicide chosen from (i) a strobilurin or strobilurin-type fungicide or (ii) a triazole or an insecticide chosen from (i) an avermectin, (ii) an organophosphate, (iii) a benzoylurea or (iv) a neonicotinoid.

10. The method of claim 9, wherein a strobilurin is chosen.

11. The method of claim 10, wherein the strobilurin is azoxystrobin.

12. The method of claim 10, wherein the crop plant is a tea, tomato, carrot, soybean or strawberry plant.

13. The method of claim 12, wherein the crop plant is a tea plant.
